(19) United States
(12) Patent Application Publication
(10) Pub. No.: US 2026/0279299 A1
(43) Pub. Date: Sep. 17, 2026

(54) DRIVER AND ELECTRO-OPTICAL APPARATUS

(71) Applicant: SEIKO EPSON CORPORATION, Tokyo (JP)

(72) Inventor: Akira MORITA, CHINO-SHI (JP)

(73) Assignee: SEIKO EPSON CORPORATION, Tokyo (JP)

(21) Appl. No.: 19/567,358

(22) Filed: Mar. 16, 2026

(30) Foreign Application Priority Data
Mar. 17, 2025 (JP) 2025-042101

(51) Int. Cl. G09G 3/36; G02F 1/133

(52) U.S. Cl. CPC G09G 3/3648; G02F 1/13306; G09G 2310/08; G09G 2340/16

(57) ABSTRACT

A driver includes first to n-th capacitors provided between an output terminal and first to n-th capacitor driving nodes, a capacitor driving circuit configured to output first to n-th capacitor driving voltages corresponding to capacitive driving data to the first to n-th capacitor driving nodes, and a control circuit configured to output the capacitive driving data based on gradation data. The control circuit sets the capacitive driving data in a way that an amount of electric charge at a node of the output terminal is changed by an amount of change in electric charge greater than an amount of change in electric charge corresponding to an amount of change in the gradation data in a predetermined period where the gradation data changes.

The present application is based on, and claims priority from JP Application Serial Number 2025-042101, filed Mar. 17, 2025, the disclosure of which is hereby incorporated by reference herein in its entirety.

### BACKGROUND

### 1. Technical Field

The present disclosure relates to a driver, an electro-optical apparatus, and the like.

### 2. Related Art

JP-A-2016-080805 discloses a driver that capacitively drives an electro-optical panel. The driver disclosed in JP-A-2016-080805 includes a capacitor circuit coupled to a data voltage output terminal, a capacitor drive circuit that drives the capacitor circuit, and a variable capacitance circuit coupled to the data voltage output terminal. The capacitance of the variable capacitance circuit is set such that the capacitance of the capacitor circuit and the sum of the capacitance of the variable capacitance circuit and electro-optical-panel-side capacitance have a predetermined capacitance ratio relationship.

JP-A-2016-080805 is an example of the related art.

In JP-A-2016-080805, electric charge redistribution is performed between the capacitance of the capacitor circuit and the sum of the capacitance of the variable capacitance circuit and the electro-optical-panel-side capacitance to speed up writing to pixels, as compared with amplifier driving. However, since the time constant of the electric charge redistribution is determined by the resistance and the like in the path where the electric charge redistribution is performed, it is desired to reduce the influence of the time constant to further increase the writing speed. For example, the time constant of the electric charge redistribution cannot be reduced in some cases due to an input resistor provided for electrostatic protection of the electro-optical panel, a decrease in thickness of wires such as data lines to achieve high resolution and a resultant increase in resistance of the wires, or any other reason.

### SUMMARY

An aspect of the present disclosure relates to a driver including: first to n-th capacitors provided between an output terminal electrically coupled to a signal supply line of an electro-optical panel and first to n-th capacitor driving nodes (n is an integer greater than or equal to two); a capacitor driving circuit configured to output first to n-th capacitor driving voltages corresponding to capacitive driving data to the first to n-th capacitor driving nodes; and a control circuit configured to output the capacitive driving data based on gradation data,
and the control circuit is configured to set the capacitive driving data in a way that an amount of electric charge at a node of the output terminal is changed by an amount of change in electric charge greater than an amount of change in electric charge corresponding to an amount of change in the gradation data in a predetermined period containing a change timing when the gradation data changes.

Another aspect of the present disclosure relates to an electro-optical apparatus including the driver described above and the electro-optical panel described above.

### BRIEF DESCRIPTION OF THE DRAWINGS

FIG. 1 shows an example of the configuration of an electro-optical apparatus.

FIG. 2 shows an example of the configuration of a display system, and an example of a detailed configuration of a driver in a first embodiment.

FIG. 3 is an example of a detailed configuration of a processing circuit in the first embodiment.

FIG. 4 illustrates overdriving in the first embodiment.

FIG. 5 shows the correspondence between gradation data and data voltage in the first embodiment.

FIG. 6 shows an example of a detailed configuration of a variable capacitance circuit, and an example of detailed configurations of a capacitor circuit and a capacitor driving circuit in the first embodiment.

FIG. 7 shows an example of a detailed configuration of a reference voltage generating circuit, a D/A conversion circuit, and an amplifier circuit.

FIG. 8 shows an example of a detailed configuration of an electro-optical panel.

FIG. 9 shows an example of signal waveforms when the overdrive function is off.

FIG. 10 shows an example of the signal waveforms in the first embodiment when the overdrive function is on.

FIG. 11 shows examples of an overdrive coefficient.

FIG. 12 is an example of a detailed configuration of a driver in a second embodiment.

FIG. 13 shows an example of detailed configurations of a capacitor circuit and a capacitor driving circuit in the second embodiment.

FIG. 14 is an example of a detailed configuration of a processing circuit in the second embodiment.

FIG. 15 shows the correspondence between gradation data and data voltage in the second embodiment.

FIG. 16 shows an example of the signal waveforms in the second embodiment when the overdrive function is on.

FIG. 17 illustrates a case where an approach in a third embodiment is applied to the first embodiment.

FIG. 18 illustrates a case where the approach in the third embodiment is applied to the second embodiment.

FIG. 19 shows an example of the signal waveforms produced when no overflow occurs.

FIG. 20 shows an example of the signal waveforms produced when an overflow occurs.

FIG. 21 illustrates extension of a period when an overflow occurs.

FIG. 22 shows an example of the configuration of an electronic instrument.

### DESCRIPTION OF EMBODIMENTS

Preferred embodiments of the present disclosure will be described below in detail. Note that the embodiments described below do not unduly limit the content described in the claims, and that all the configurations described in the embodiments are not necessarily essential configuration requirements. Note that coupling in the embodiments includes electrical coupling. The electrical coupling refers to coupling that allows transmission of an electric signal, a voltage, or a current, and includes coupling that allows transmission of information by an electrical signal. The electrical coupling may be coupling via a passive element or an active element.

### 1. Electro-Optical Apparatus

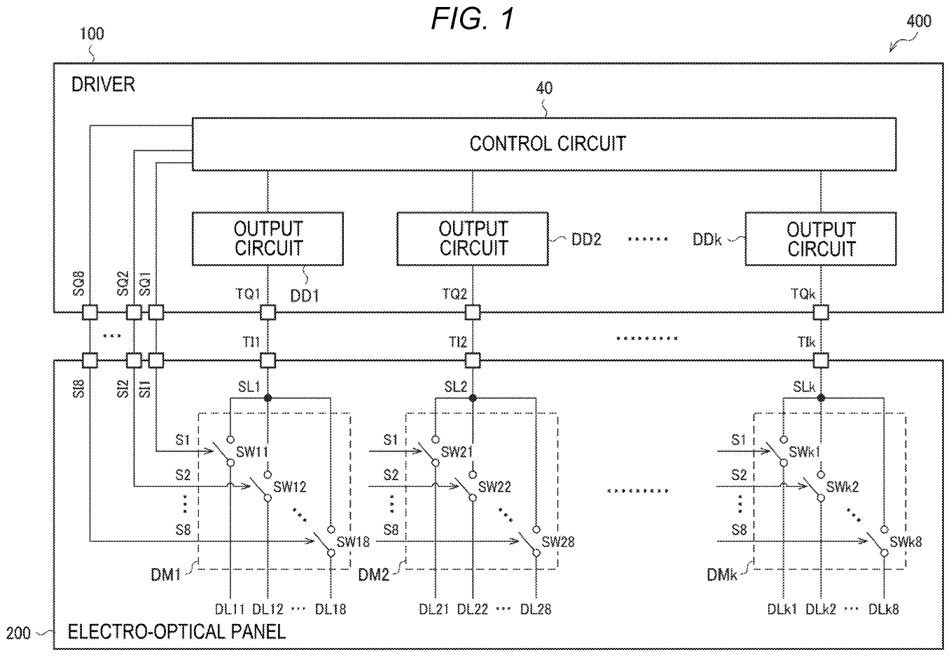

FIG. 1 shows an example of the configuration of an electro-optical apparatus 400. The electro-optical apparatus 400 includes a driver 100 and an electro-optical panel 200. The following description will be made with reference to the electro-optical apparatus 400 of a demultiplexing driving type, but the electro-optical apparatus 400 is not limited thereto, and may, for example, be of a phase expanded driving type. The following description will be further made with reference to a case where the number of demultiplexing numbers is eight, but the number of demultiplexing numbers may be p. p is an integer greater than or equal to two.

The driver 100 includes a control circuit 40, output circuits DD1 to DDk, output terminals TQ1 to TQk, and control signal output terminals SQ1 to SQ8. k is an integer greater than or equal to two. The driver 100 is, for example, an integrated circuit device in which multiple circuit elements are integrated in a semiconductor substrate. The output terminals TQ1 to TQk are, for example, pads provided on the semiconductor substrate, or lead terminals or bump terminals provided at a package of the integrated circuit device.

The electro-optical panel 200 includes input terminals TI1 to TIk, signal supply lines SL1 to SLk, demultiplexers DM1 to DMk, data lines DL11 to DL18, DL21 to DL28, . . . , DLk1 to DLk8, and control signal input terminals SI1 to SI8. The electro-optical panel 200 is an active-matrix liquid crystal display panel, an EL display panel using self-luminous elements, or the like. EL is an abbreviation for electro-luminescence.

The control circuit 40 outputs, to the output circuit DD1, corresponding gradation data. The output circuit DD1 converts the gradation data into a data voltage and outputs the data voltage to the output terminal TQ1. The output terminal TQ1 is coupled to the input terminal TI1, and the input terminal TI1 is coupled to the signal supply line SL1. The output circuits DD2 to DDk, the output terminals TQ2 to TQk, the input terminals TI2 to TIk, and the signal supply lines SL2 to SLk are configured in the same manner.

The demultiplexer DM1 includes switches SW11 to SW18. The switches are each, for example, TFTs. TFT is an abbreviation for thin film transistor. One end of the switch SW11 is coupled to the signal supply line SL1, and the other end thereof is coupled to the data line DL11. The switch SW11 is controlled to be turned on or off by a control signal S1. Similarly, one end of each of the switches SW12 to SW18 is coupled to the signal supply line SL1, and the other ends of the switches SW12 to SW18 are coupled to the data lines DL12 to DL18. The switches SW12 to SW18 are controlled to be turned on or off by control signals S2 to S8. The demultiplexers DM2 to DMk, the switches SW21 to SW28, . . . , SWk1 to SWk8, and the data lines DL21 to DL28, . . . , DLk1 to DLk8 are configured in the same manner. The number of the switches and the number of the data lines in each of the demultiplexers may be p, which is equal to the number of the demultiplexes.

Although not shown in FIG. 1, multiple pixels are arranged in a matrix in the electro-optical panel 200. One data line and one scanning line are coupled to each of the pixels. A scanning line is selected by a scanning line drive circuit that is not shown. The scanning line drive circuit may be provided in the driver 100 or may be provided outside the driver 100.

The demultiplexing driving will be described with reference to the output circuit DD1. During one horizontal scanning period, the switches SW11, SW12, . . . , SW18 are sequentially turned on. When the switch SW11 is on, the output circuit DD1 writes the data voltage to the pixel coupled to the data line DL11. Similarly, when the switches SW12, . . . , SW18 are on, the output circuit DD1 writes the data voltage to the pixels coupled to the data lines DL12, . . . , DL18. Note that the switches may be turned on, for example, in rotation in the demultiplexing driving, and that the switches SW11, SW12, . . . , and SW18 may be turned on in any order. The data voltage is a voltage written to one pixel at a time. The demultiplexing driving drives the eight pixels in time series, and outputs a data voltage for each of the eight pixels to the signal supply line as a time-series signal. The time-series signal may also be called a data signal. During the horizontal scanning period, pre-charge, post-charge, or both may be performed in addition to the operation of driving the pixels.

### 2. First Embodiment

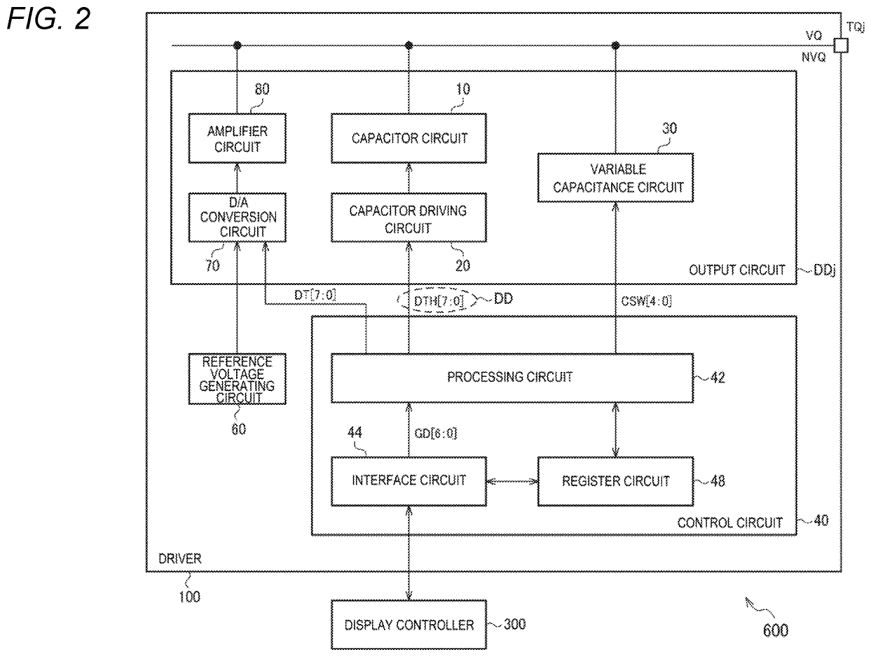

FIG. 2 shows an example of the configuration of a display system 600, and an example of a detailed configuration of the driver 100 in the first embodiment. The display system 600 includes a display controller 300 and the driver 100. The driver 100 includes an output circuit DDj, the control circuit 40, and a reference voltage generating circuit 60. The output circuit DDj is any one of the output circuits DD1 to DDk in FIG. 1. The suffix j is an integer greater than or equal to 1 but smaller than or equal to k. The reference voltage generating circuit 60 is provided as a circuit common to the output circuits DD1 to DDk. The output circuit DDj includes a capacitor circuit 10, a capacitor driving circuit 20, a variable capacitance circuit 30, a D/A conversion circuit 70, and an amplifier circuit 80. The control circuit 40 includes a processing circuit 42, an interface circuit 44, and a register circuit 48. Note that an output node NVQ is a node coupled to an output terminal TQj, and the voltage at the output node NVQ is assumed to be an output voltage VQ.

The interface circuit 44 performs interfacing between the display controller 300, which controls the driver 100, and the driver 100. The interface circuit 44 outputs gradation data GD[6:0] received from the display controller 300 to the processing circuit 42. Note that the received gradation data may have any number of bits. The interface circuit 44 is an image interface circuit that operates, for example, in an LVDS method, a parallel RGB method, or a display port method. LVDS is an abbreviation for low voltage differential signaling.

The processing circuit 42 outputs gradation data DTH[7:0] for capacitive driving to the capacitor driving circuit 20 based on the gradation data GD[6:0]. The capacitor driving circuit 20 drives the capacitor circuit 10 based on the gradation data DTH[7:0]. The thus driven capacitor circuit 10 injects electric charge into the output node NVQ or discharges electric charge from the output node NVQ, and the electric charge is redistributed in accordance with the capacitance of the capacitor circuit 10, the variable capacitance circuit 30, and the electro-optical panel 200. The output voltage VQ thus becomes a data voltage corresponding to the gradation data DTH[7:0]. The driving described above is called capacitive driving.

Note that data used to perform the capacitive driving, that is, data that the control circuit 40 outputs to the capacitor driving circuit 20 based on the gradation data GD[6:0] is called capacitive driving data DD. In the first embodiment, the capacitive driving data DD is the gradation data DTH[7:0] for capacitive driving. Note, however, that the capacitive driving data DD contains in some cases data generated based on the gradation data GD[6:0] in addition to the gradation data DTH[7:0], as in a second embodiment described later.

The processing circuit 42 outputs gradation data DT[7:0] for amplifier driving based on the gradation data GD[6:0]. The reference voltage generating circuit 60 generates a reference voltage corresponding to each gradation value of the gradation data DT[7:0]. Specifically, 256 reference voltages corresponding to gradation values 0 to 255 are generated. The D/A conversion circuit 70 D/A-converts the gradation data DT[7:0] based on the multiple reference voltages from the reference voltage generating circuit 60. Specifically, the D/A conversion circuit 70 selects a reference voltage corresponding to the gradation data DT[7:0] from the 256 reference voltages, and outputs the selected reference voltage to the amplifier circuit 80. The amplifier circuit 80 buffers the voltage output from the D/A conversion circuit 70, and outputs the buffered voltage to the output node NVQ.

Note that the processing circuit 42 may output, to the D/A conversion circuit 70, gradation data for amplifier driving having bits the number of which differs from that of the gradation data for capacitive driving. Note, however, that the data voltage to be output by the capacitive driving and the data voltage to be output by the amplifier circuit 80 have the same voltage value in principle except for bit accuracy.

The data voltage output by the capacitive driving causes a voltage error due, for example, to an electric charge storage error, but the amplifier circuit 80 absorbs the voltage error of the data voltage by absorbing the electric charge error. When the electric charge error is sufficiently small or corrected, the reference voltage generating circuit 60, the D/A conversion circuit 70, and the amplifier circuit 80 may be omitted.

The register circuit 48 stores various data used to set the operation of the driver 100. For example, the register circuit 48 stores setting data CSW[4:0], which sets the capacitance value of the variable capacitance circuit 30. For example, the display controller 300 writes the setting data CSW[4:0] to the register circuit 48 via the interface circuit 44. The driver 100 may instead include a nonvolatile memory that is not shown but stores the setting data CSW[4:0] in advance, and a correction coefficient and the setting data CSW[4:0] may be loaded from the nonvolatile memory to the register circuit 48. The processing circuit 42 sets the capacitance value of the variable capacitance circuit 30 by outputting the setting data CSW[4:0] read from the register circuit 48 to the variable capacitance circuit 30.

Note that the control circuit 40 is operated, for example, by a power supply voltage for logic elements. The output circuit DDj and the reference voltage generating circuit 60 are operated, for example, by a power supply voltage for panel driving higher than the power supply voltage for logic elements. The power supply voltage for panel driving may be hereinafter simply called a “power supply voltage”.

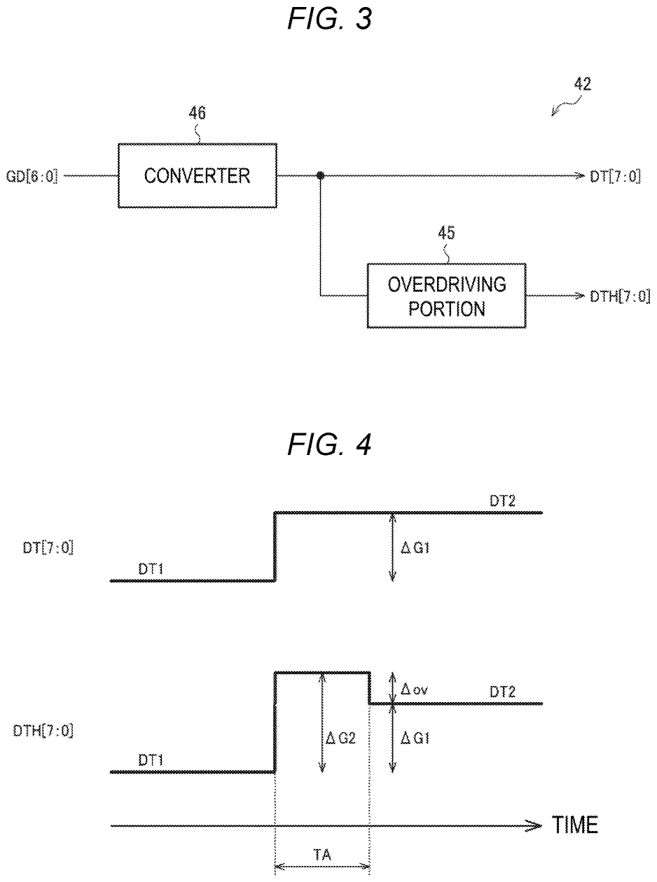

FIG. 3 is an example of a detailed configuration of the processing circuit 42 in the first embodiment. FIG. 3 is a block diagram related to overdriving. The processing circuit 42 includes an overdriving portion 45 and a converter 46.

The converter 46 converts the gradation data GD[6:0] into the gradation data DT[7:0] for amplifier driving, and outputs the gradation data DT[7:0] to the D/A conversion circuit 70. The overdriving portion 45 performs the overdriving on the gradation data DT[7:0], and outputs the resultant gradation data to the capacitor driving circuit 20 as the gradation data DTH[7:0] for capacitive driving. Note that when the amplifier circuit 80 is omitted, the processing circuit 42 may process the gradation data DT[7:0] as internal data without outputting the gradation data DT[7:0] to an external element.

The configuration of the processing circuit 42 is not limited to that shown in FIG. 3. For example, the overdriving portion 45 may perform the overdriving on the gradation data GD[6:0], and the converter 46 may convert the gradation data after the overdriving into the gradation data DTH[7:0] for capacitive driving.

FIG. 4 illustrates the overdriving in the first embodiment. In the operation of driving the pixels, the gradation data DT[7:0] changes to gradation data DT1 used to drive a certain pixel, and gradation data DT2 used to drive the next pixel. The overdriving portion 45 performs the overdriving in a period TA where the gradation data DT[7:0] changes.

Specifically, the overdriving portion 45 outputs DTH[7:0]=DT2+Δov in the period TA, and then outputs the input gradation data DT2 as it is. Δov is the amount of overdrive. The processing circuit 42 determines the amount of overdrive Δov based on a first amount of change ΔG1, which is the difference in gradation between DT1 and DT2. Since DT2+Δov=DT1+(ΔG1+Δov) is satisfied, it can be said that the gradation data DTH[7:0] changes in the period TA from DT1 by a second amount of change ΔG2=ΔG1+Δov. The second amount of change ΔG2 is greater than the first amount of change ΔG1. For example, the processing circuit 42 determines the amount of overdrive by using Δov=Cov×ΔG1. Cov is an overdrive coefficient, which is greater than 0 but smaller than 1. As an example, Cov is in a range between about 0.1 to 0.2, in which case, the second amount of change ΔG2 is about 1.1 to 1.2 times the first amount of change ΔG1.

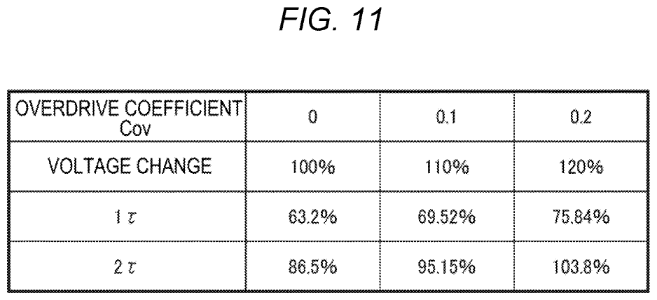

The period TA is a period having a predetermined length and starting from the timing at which the gradation data DT[7:0] changes. The length of the period TA may be set as appropriate in accordance, for example, with the overdrive coefficient Cov. As an example, let τ be the time constant of electric charge redistribution, and the length of the period TA may be in a range between about 1τ to 2τ, as will be described later with reference to FIG. 11 FIG. 11.

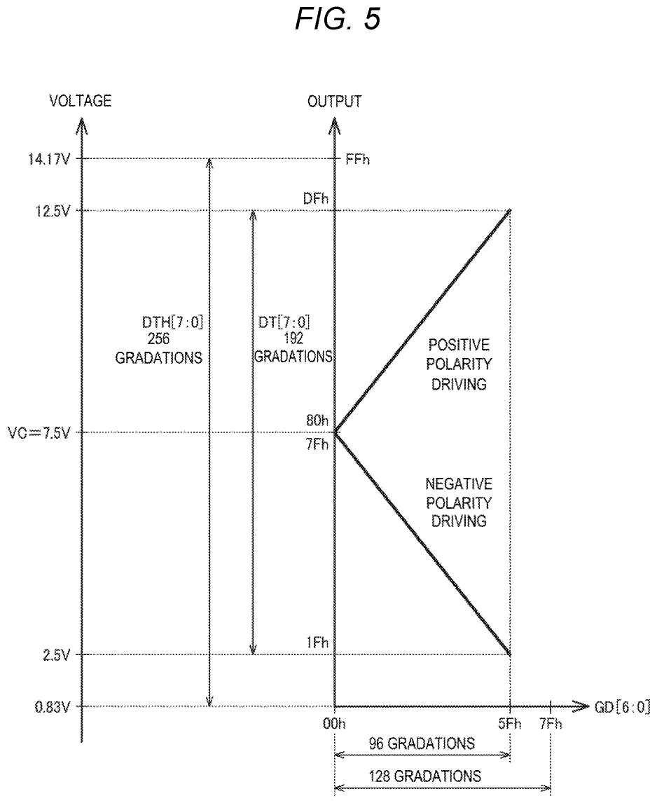

FIG. 5 shows the correspondence between the gradation data and the data voltage in the first embodiment. FIG. 5 shows a case where polarity inversion driving is assumed and a common voltage VC in the polarity inversion driving is assumed to be 7.5 V. Note that “h” at the end of each numeral indicates that the numeral is a hexadecimal number.

The gradation data GD[6:0] has 128 gradations from 00h to 7Fh. As pixel data used to display an image, 96 gradations from 00h to 5Fh are used, and the converter 46 converts the gradation data GD[6:0] indicating the 96 gradations into the gradation data DT[7:0] corresponding to the polarity inversion driving. In positive polarity driving, the converter 46 converts the gradation data GD[6:0]=00h, 01h, 02h, . . . , 5Fh into the gradation data DT[7:0]=80h, 81h, 82h, . . . , DFh. In negative polarity driving, the converter 46 converts the gradation data GD[6:0]=00h, 01h, 02h, . . . , 5Fh into the gradation data DT[7:0]=7Fh, 7Eh, 7Dh, . . . , 1Fh. In the capacitive driving, a voltage in a range between 2.5 V and 12.5 V is output for 192 gradations from 1Fh to DFh of the gradation data DT[7:0]. Specifically, a voltage in a range between 7.5 V and 12.5 V is output for 80h to DFh in the positive polarity driving, and a voltage in a range between 7.5 V and 2.5 V is output for 7Fh to 1Fh in the negative polarity driving.

The overdriving portion 45 receives the gradation data DT[7:0] indicating 192 gradations, and outputs the gradation data DTH[7:0] indicating 256 gradations. Out of the entire gradation data, 32 gradations from DFh to FFh and 32 gradations from 1Fh to 00h are used only for the overdriving. For example, in the positive polarity driving, when the gradation data DT[7:0] changes from GD1=00h=128 to GD2=DFh=223, the amount of change ΔG1 is 191. When the overdrive coefficient Cov is set to ⅙, DTH[7:0]=223+191×(⅙)≈255=FFh. To secure such room for the overdriving, the gradation range for pixel display is 192 gradations from 20h to DFh. In the capacitive driving, a voltage in a range between 0.83 V and 14.17 V is output for the 256 gradations of 00h to FFh of the gradation data DTH[7:0].

Note that typical image data indicating an unlimited number of gradations may be input to the processing circuit 42. For example, the processing circuit 42 may accept gradation data indicating 6-bit 64 gradations, generate the gradation data GD[6:0] indicating 7-bit 96 gradations by multiplying the accepted gradation data by 1.5, and input the generated gradation data GD[6:0] to the converter 46.

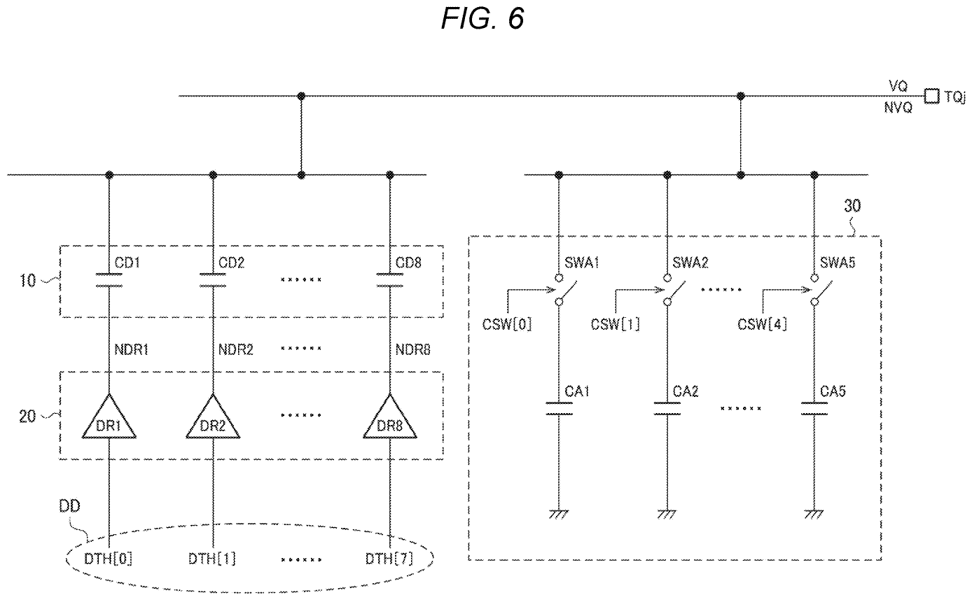

FIG. 6 shows an example of a detailed configuration of the variable capacitance circuit 30, and an example of detailed configurations of the capacitor circuit 10 and the capacitor driving circuit 20 in the first embodiment. The capacitor circuit 10 includes capacitors CD1 to CD8, which are first to eighth capacitors. The capacitor driving circuit 20 includes driving circuits DR1 to DR8, which are first to eighth driving circuits. Note that the number of the capacitors and the driving circuits only needs to be equal to the number of bits of the capacitive driving data DD, and may be n. n is an integer greater than or equal to two.

One end of a capacitor CDi is coupled to the output node NVQ, and the other end thereof is coupled to a capacitor driving node NDRi. i is an integer greater than or equal to one but smaller than or equal to eight. The capacitance values of the capacitors CD1 to CD8 are binary-weighted. Specifically, the capacitance value of the capacitor CDi is 2⁽ⁱ⁻¹⁾×CD1.

The processing circuit 42 outputs an i-th bit DTH[i−1] of the gradation data DTH[7:0] to the input node of a drive circuit DRi. The drive circuit DRi outputs a capacitor drive voltage according to the logic level of the i-th bit DTH[i−1] to the capacitor driving node NDRi. That is, the drive circuit DRi outputs a first voltage level to the capacitor driving node NDRi when the i-th bit DTH[i−1] is a first logic level, and outputs a second voltage level to the capacitor driving node NDRi when the i-th bit DTH[i−1] is a second logic level. For example, the first logic level is “0”, the second logic level is “1”, the first voltage level is the ground voltage, and the second voltage level is the power supply voltage. The drive circuit DRi includes, for example, a level shifter that level-shifts an input logic level to an output voltage level of the drive circuit DRi, and a buffer circuit that buffers an output of the level shifter.

When the drive circuits DR1 to DR8 drive the capacitors CD1 to CD8, electric charge redistribution occurs among the capacitors CD1 to CD8, the variable capacitance circuit 30, and the electro-optical panel-side capacitance. As a result, data voltages are written to the pixels. Note that the electro-optical panel-side capacitance is capacitance seen by the panel via the output terminal TQj when the pixels are driven.

The variable capacitance circuit 30 includes adjustment switches SWA1 to SWA5 and adjustment capacitors CA1 to CA5. Note that the number of the switches and the adjustment capacitors may be m. m is an integer greater than or equal to two. The number of bits of the setting data CSW[4:0] is equal to the number of the adjustment capacitors, and may be m.

One end of an adjustment switch SWAs is coupled to the output node NVQ, and the other end thereof is coupled to one end of an adjustment capacitor CAs. The other end of the adjustment capacitor CAs is coupled to a constant-voltage node such as a ground node. s is an integer greater than or equal to one but smaller than or equal to five. The adjustment switches SWA1 to SWA5 are, for example, P-type MOS transistors, N-type MOS transistors, or transfer gates. The adjustment capacitors CA1 to CA5 have binary-weighted capacitance values. Specifically, the capacitance value of the adjustment capacitor CAs is 2^{(s-1)}×CA1.

The adjustment switch SWAs is controlled to be turned on or off by an s-th bit CSW[s−1] of CSW[4:0]. When the adjustment switch SWAs is on, the adjustment capacitor CAs is coupled to the output node NVQ, and the capacitance value of the adjustment capacitor CAs is added to the capacitance value of the variable capacitance circuit 30. That is, the capacitance value of the variable capacitance circuit 30 is set in accordance with whether the adjustment switches SWA1 to SWA5 are each on or off.

The relationship of the capacitance values of the capacitor circuit 10 and the variable capacitance circuit 30 with the output voltage VQ will be described. The power supply voltage of the drive circuits DR1 to DR8 of the capacitor driving circuit 20 is assumed to be 15.5 V. Let CD be the total capacitance value of the capacitors CD1 to CD8, and CA be the capacitance value of the variable capacitance circuit 30. Let CLCD be the electro-optical-panel-side capacitance viewed from the output terminal TQj. The capacitance CLCD contains parasitic capacitance of the wire that couples the output terminal TQj to an input terminal TIj, parasitic capacitance of a signal supply line SLj, and parasitic capacitance of one data line. The maximum amplitude of the capacitive driving is expressed by CD/(CD+CA+CLCD)×15.5 V. The maximum amplitude of the capacitive driving in the description means the amplitude of the capacitive driving performed when the gradation data DTH[7:0] changes from 00h to FFh.

When it is desired to set the maximum amplitude of the capacitive driving to VAM, the capacitance value CA of the variable capacitance circuit 30 is set such that VAM=CD/(CD+CA+CLCD)×15.5 V. For example, VAM=13.33 V in FIG. 5. Since the capacitance values of the capacitors CD1 to CD8 are binary-weighted, the output voltage VQ linearly changes over the voltage amplitude VAM as the gradation data DTH[7:0] changes from 00h to FFh. For example, the output voltage VQ changes from 0.83 V to 14.17 V in FIG. 5.

The capacitance value CA of the variable capacitance circuit 30 may be determined, for example, as follows. A target value of the output voltage VQ provided when certain gradation data DTH[7:0] is input to the capacitor driving circuit 20 is known. Predetermined gradation data DTH[7:0] may therefore be input to the capacitor driving circuit 20, and the capacitance value CA of the variable capacitance circuit 30 may be so determined that the resultant output voltage VQ becomes the target voltage. For example, the driver 100 may include a monitoring circuit that monitors the output voltage VQ, and the processing circuit 42 may determine the capacitance value CA of the variable capacitance circuit 30 based on the result of the monitoring. Instead, an inspection apparatus may monitor the voltage at the output terminal TQj, for example, in an inspection step executed when the electro-optical apparatus 400 is manufactured, and the capacitance value CA of the variable capacitance circuit 30 may be determined based on the result of the monitoring. Still instead, the capacitance value CA of the variable capacitance circuit 30 may be determined by using a circuit simulation.

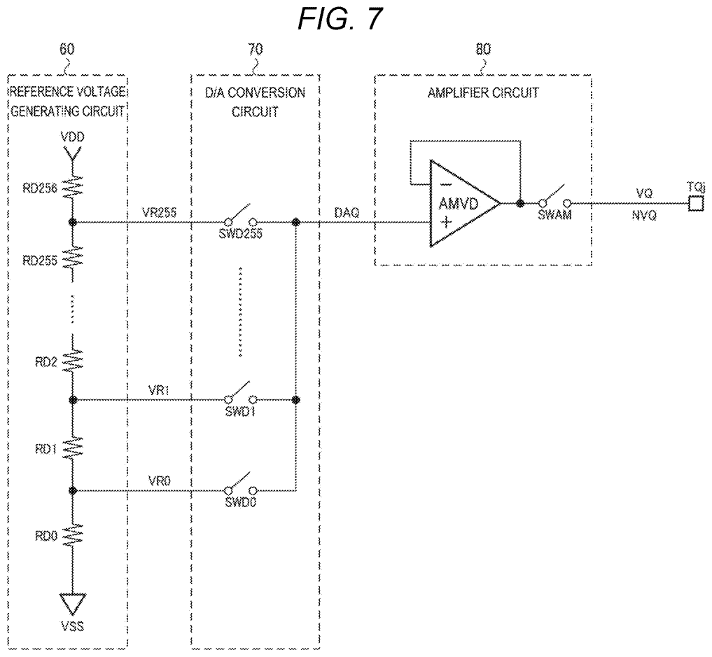

FIG. 7 shows an example of a detailed configuration of the reference voltage generating circuit 60, the D/A conversion circuit 70, and the amplifier circuit 80.

The reference voltage generating circuit 60 includes resistors RD0 to RD256 coupled to each other in series between a node having a ground voltage VSS and a node having a power supply voltage VDD. A reference voltage VR0 is output to a node between the resistor RD0 and the resistor RD1. The reference voltage VR0 is a voltage corresponding to the gradation value 0. Similarly, reference voltages VR1 to VR255 are output to nodes between the resistors RD1 and RD2, . . . , between resistors RD255 and RD256. The reference voltages VR1 to VR255 are voltages corresponding to the gradation values 1 to 255.

The D/A conversion circuit 70 includes switches SWD0 to SWD255. The switches are each an analog switch, for example, an N-type transistor, a P-type transistor, or a transfer gate configured with the two types of transistors coupled in parallel to each other. The reference voltage VR0 is input to one end of the switch SWD0. Similarly, the reference voltages VR1 to VR255 are each input to one end of corresponding one of the switches SWD1 to SWD255. The other ends of the switches SWD0 to SWD255 are coupled in common. When the gradation value of the gradation data DTH[7:0] is 0, the switch SWD0 is turned on, and the D/A conversion circuit 70 outputs the reference voltage VR0 as an output voltage DAQ. Similarly, when the gradation value is any of 1 to 255, the corresponding one of the switches SWD1 to SWD255 is turned on, and the D/A conversion circuit 70 outputs the corresponding one of the reference voltages VR1 to VR255 as the output voltage DAQ. Note that the configuration of the D/A conversion circuit 70 is not limited to that shown in FIG. 7. For example, the D/A conversion circuit 70 may employ a tournament method in which switches are provided in multiple stages and a switch is selected in a single elimination method.

The amplifier circuit 80 includes an operational amplifier AMVD and a switch SWAM. The output voltage DAQ from the D/A conversion circuit 70 is input to the non-inverted input terminal of the operational amplifier AMVD. The output terminal and the inverted input terminal of the operational amplifier AMVD are coupled to each other to form what is called a voltage follower circuit. The switch SWAM is an analog switch, for example, an N-type transistor, a P-type transistor, or a transfer gate configured with the two types of transistors coupled in parallel to each other. One end of the switch SWAM is coupled to the output terminal of the operational amplifier AMVD, and the other end thereof is coupled to the output node NVQ. The switch SWAM couples the output from the voltage follower circuit with the output node NVQ or decouples the former from the latter based on a control signal from the control circuit 40. For example, in the period for which one pixel is driven, the switch SWAM is off at the start of the capacitive driving, and is turned on after a certain period has elapsed since the start of the capacitive driving.

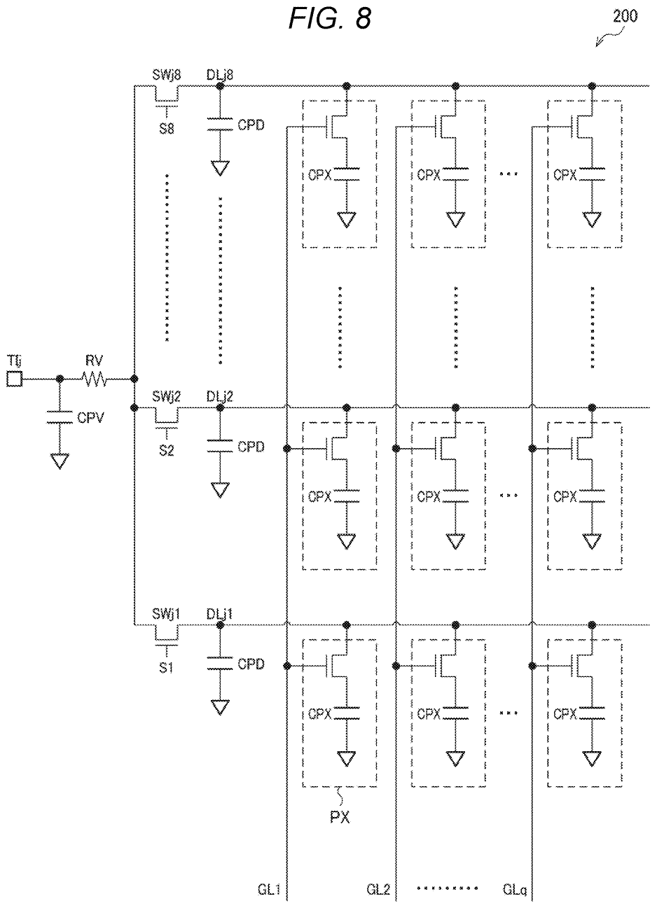

FIG. 8 shows an example of a detailed configuration of the electro-optical panel 200. The configuration of the electro-optical panel 200 will be illustrated and described below with reference to a portion related to a demultiplexer DMj.

The electro-optical panel 200 includes the input terminal TIj, an input resistor RV, switches SWj1 to SWj8 of the demultiplexer DMj, data lines DLj1 to DLj8, scanning lines GL1 to GLm, and multiple pixels PX arranged in a matrix. Note that capacitance CPV and capacitance CPD are each parasitic capacitance and do not exist as circuit elements.

The input resistor RV is provided between the input terminal TIj and the switches SWj1 to SWj8. The parasitic capacitance CPV is parasitic capacitance in the path from the output terminal TQj of the driver 100 to the switches SWj1 to SWj8 of the electro-optical panel 200. The parasitic capacitance CPV includes parasitic capacitance of the wire that couples the output terminal TQj of the driver 100 to the input terminal TIj of the electro-optical panel 200, and parasitic capacitance of the signal supply line SLj in the electro-optical panel 200. The parasitic capacitance CPD is parasitic capacitance of one data line. The pixels PX each include a pixel transistor and pixel capacitance CPX. When the electro-optical panel 200 is a liquid crystal display panel, the pixel capacitance CPX includes a liquid crystal material and two electrodes disposed to face each other with the liquid crystal material interposed therebetween. The source of each of the pixel transistors is coupled to a data line, the gate thereof is coupled to a scanning line, and the drain thereof is coupled to one end of the pixel capacitance CPX. The other end of the pixel capacitance CPX is coupled to the ground. Note that the electro-optical-panel-side capacitance value used in the description of FIG. 6 is CLCD=CPV+CPD+CPX when the pixel is driven.

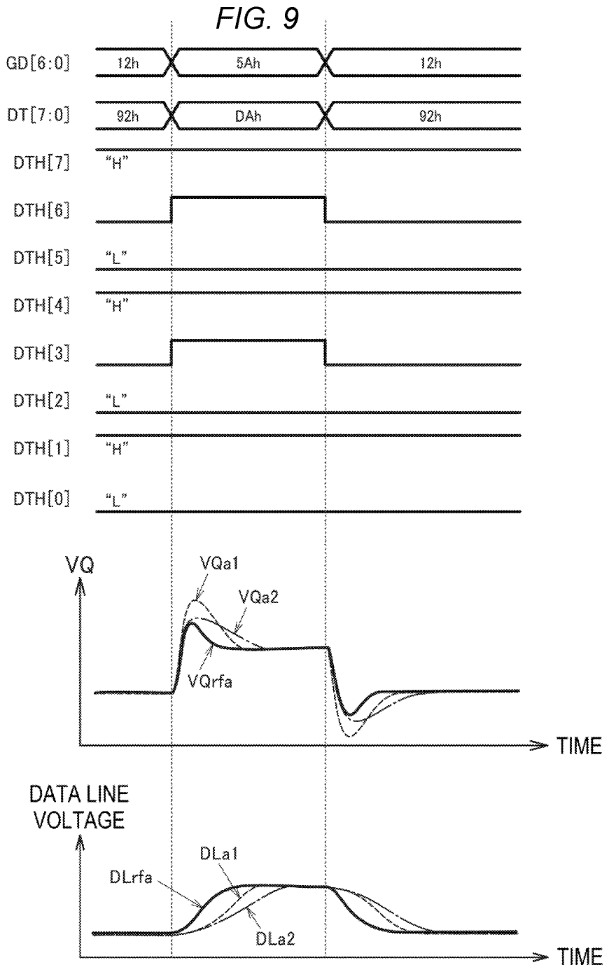

FIG. 9 shows an example of signal waveforms produced when the overdrive function is off. FIG. 9 shows a case where the gradation data GD[6:0] sequentially changes to 12h, 5Ah, and 12h in the positive polarity driving. For example, in the demultiplexing driving, 12h, 5Ah, and 12h each correspond to the operation of driving one pixel. The gradation data DT[7:0] after the conversion is 92h, DAh, and 92h. The target value of the data voltage sequentially changes to 8.44 V, 12.19 V, and 8.44 V.

When the overdrive function is off, the overdriving portion 45 outputs the gradation data DT[7:0] as it is as the gradation data DTH[7:0]. The capacitive driving is performed based on the gradation data DTH[7:0], and is equivalent in the description to the capacitive driving being performed based on the gradation data DT[7:0]. When the gradation data DT[7:0] changes from 92h to DAh, electric charge is supplied from the capacitor circuit 10 to the output node NVQ. When the electric charge is distributed to the data lines of the electro-optical panel 200, both the voltage VQ at the output node NVQ and the data line voltage become a target voltage of 12.19 V. In the distribution process, the electric charge moves from the output node NVQ to the data lines via the input resistor RV of the electro-optical panel 200 and on-resistances of the switches of the demultiplexer. The voltage VQ at the output node NVQ therefore temporarily becomes higher than the target voltage and then asymptotically approaches the target voltage. The data line voltage asymptotically approaches the target voltage in response to the movement of the electric charge.

Waveforms VQrfa and DLrfa are examples of the waveforms produced when the capacitance CLCD and the input resistor RV of the electro-optical panel 200 have reference values. The reference values are each, for example, a value in a specific model of the electro-optical panel 200. The capacitance CLCD and the input resistor RV vary depending on the model of the electro-optical panel 200, and the capacitance CLCD may be greater than the reference value in some models or the input resistor RV may have resistance greater than the reference value in other models.

Waveforms VQa1 and DLa1 are examples of the waveforms produced when the capacitance CLCD is greater than the reference value. As described above, since the capacitance value CA of the variable capacitance circuit 30 is determined by VAM=CD/(CD+CA+CLCD)×15.5 V, the capacitance value CA of the variable capacitance circuit 30 decreases when the capacitance CLCD increases. The capacitance at the output node NVQ is CD+CA, so that the capacitance at the output node NVQ decreases when CA is small, and the voltage VQ at the output node NVQ rises above a value in a reference condition and then asymptotically approaches the target voltage. Furthermore, since the parasitic capacitance of the data lines is greater than a value in the reference condition, the time constant of the electric charge movement to the data lines increases. The data line voltage therefore asymptotically approaches the target voltage over a period longer than a value in the reference condition.

Waveforms VQa2 and DLa2 are examples of the waveforms produced when the input resistor RV has resistance greater than the reference value. When the resistance of the input resistor RV increases, the time constant of electric charge redistribution increases. The voltage VQ at the output node NVQ therefore asymptotically approaches the target voltage with a time constant greater than a value in the reference condition. The data line voltage asymptotically approaches the target voltage over the period longer than the value in the reference condition.

When the gradation data DT[7:0] changes from DAh to 92h, the same phenomenon occurs except that the directions of the electric charge movement and the voltage change are opposite the directions described above.

As described above, when the capacitance CLCD or the resistance of the input resistor RV of the electro-optical panel 200 is large, the asymptotical approach of the voltage VQ at the output node NVQ and the data line voltage to the target voltages is delayed. The data line voltage needs to reach the target voltage in the pixel driving period, but when the pixel driving period shortens due to an increase in the definition, the frame rate, or any other factor of the electro-optical panel 200, it is difficult for the data line voltage to reach the target voltage within the pixel driving period.

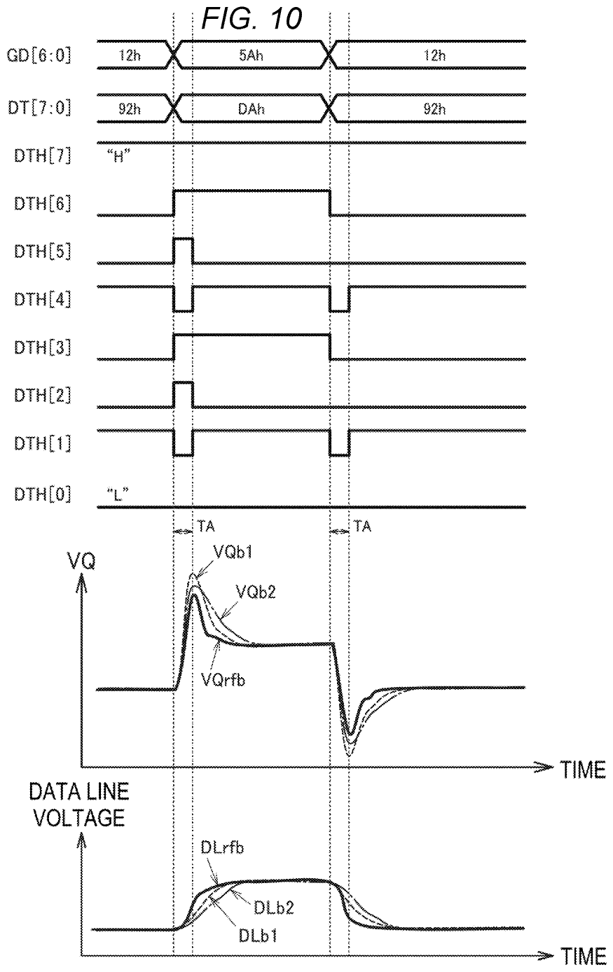

FIG. 10 shows an example of the signal waveforms in the first embodiment produced when the overdrive function is on. When the gradation data DT[7:0] changes, the overdriving portion 45 outputs the gradation data DTH[7:0]=DT[7:0]+Cov×ΔG1 in the period TA, and outputs the gradation data DTH[7:0]=DT[7:0] in the other periods. FIG. 10 shows a case where the overdrive coefficient Cov is 0.25. When the gradation data DT[7:0] changes from 92h to DAh, DTH[7:0]=DAh+0.25×(DAh−92h)=ECh=11101100b is satisfied. “b” at the end of a numeral indicates that the numeral is a binary number. When the gradation data DT[7:0] changes from DAh to 92h, DTH[7:0]=92h+0.25×(92h−DAh)=80h=10000000b is satisfied. Performing the overdriving described above causes the voltage VQ at the output node NVQ to greatly rise in the period TA. The electric charge movement from the output node NVQ to the data lines is thus accelerated, so that an effect similar to reduction in the time constant of the electric charge redistribution is provided.

Waveforms VQrfb and DLrfb are examples of the waveforms produced when the capacitance CLCD and the input resistor RV of the electro-optical panel 200 have the reference values. Waveforms VQb1 and DLb1 are examples of the waveforms produced when the capacitance CLCD is greater than the reference value. Waveforms VQb2 and DLb2 are examples of the waveforms produced when the input resistor RV has resistance greater than the reference value. In either case, the voltage VQ at the output node NVQ and the data line voltage asymptotically approach the target voltages faster than when the overdrive function is off.

FIG. 11 shows examples of the overdrive coefficient Cov. Cov=0 means that the overdrive function is off. The voltage change is a change in the data voltage that occurs when the gradation data DTH[7:0] for capacitive driving changes, and it is assumed that the voltage change is 100% when Cov=0. During the overdriving, the voltage changes are 110% and 120% for Cov=0.1, and 0.2. T is the time constant of the electric charge redistribution. When the overdrive function is off and the voltage change is 100%, the difference in voltage from the target voltage decreases by 63.2% for 1τ and decreases by 86.5% for 2τ. During the overdriving, and when the voltage change is 110%, the difference in voltage from the target voltage decreases by 69.52% for 1τ and decreases by 95.15% for 2τ. When the voltage change is 120%, the difference in voltage from the target voltage decreases by 75.84% for 1τ and decreases by 103.8% for 2τ.

According to FIG. 11, the length of the period TA, for which the overdriving is performed, may be set to a value in a range between about 1τ and 2τ, and the overdrive coefficient Cov may be set to a value in a range between about 0.1 and 0.2. For example, setting the voltage change to 110% in the period of 2τ, the difference in voltage from the target voltage decreases by 95.15%, so that the voltage becomes substantially the target voltage. Temporarily increasing the voltage change in the capacitive driving when the gradation data changes thus allows the voltage VQ at the output node NVQ to rise more than usual, so that the electric charge redistribution can be accelerated.

### 3. Second Embodiment

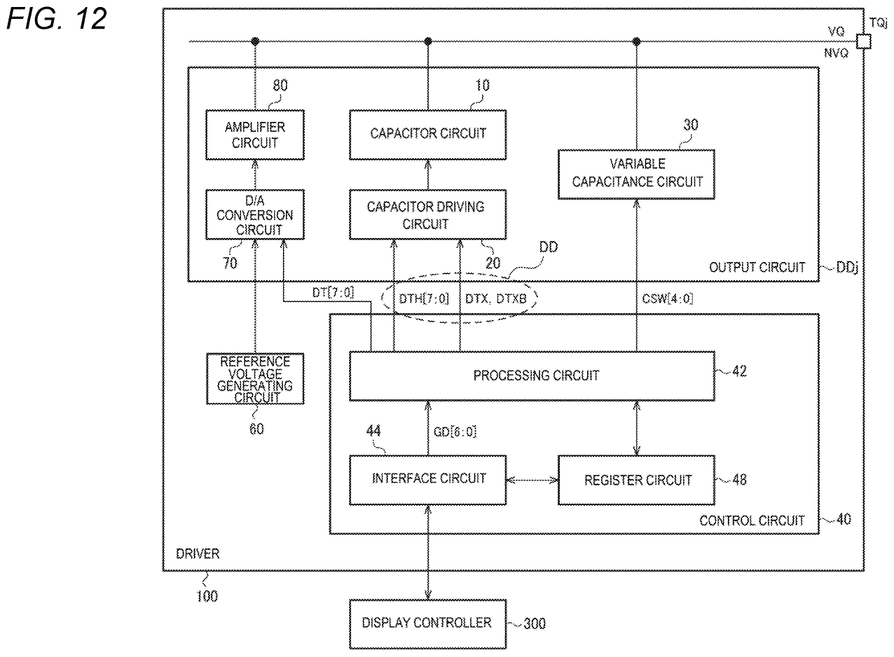

FIG. 12 shows an example of a detailed configuration of the driver 100 in a second embodiment. Differences from the first embodiment will be described below.

The processing circuit 42 outputs the gradation data DTH[7:0] for capacitive driving, a signal DTX, which is a first signal for overdriving, and a signal DTXB, which is a second signal for overdriving to the capacitor driving circuit 20 based on the gradation data GD[6:0]. The capacitor driving circuit 20 drives the capacitor circuit 10 based on the gradation data DTH[7:0] and the signals DTX and DTXB. In the second embodiment, the capacitive driving data DD includes the gradation data DTH[7:0] for capacitive driving and the signals DTX and DTXB for overdriving. The first to eighth bits of the capacitive driving data DD are the gradation data DTH[7:0], the ninth bit is the signal DTX, and the tenth bit is the signal DTXB. Note that the capacitive driving data DD may be n-bit data. In this case, the first to (n−2)-th bits of the capacitive driving data DD are gradation data DTH[n−3:0], the (n−1)-th bit is the signal DTX, and the n-th bit is the signal DTXB. n is an integer greater than or equal to four.

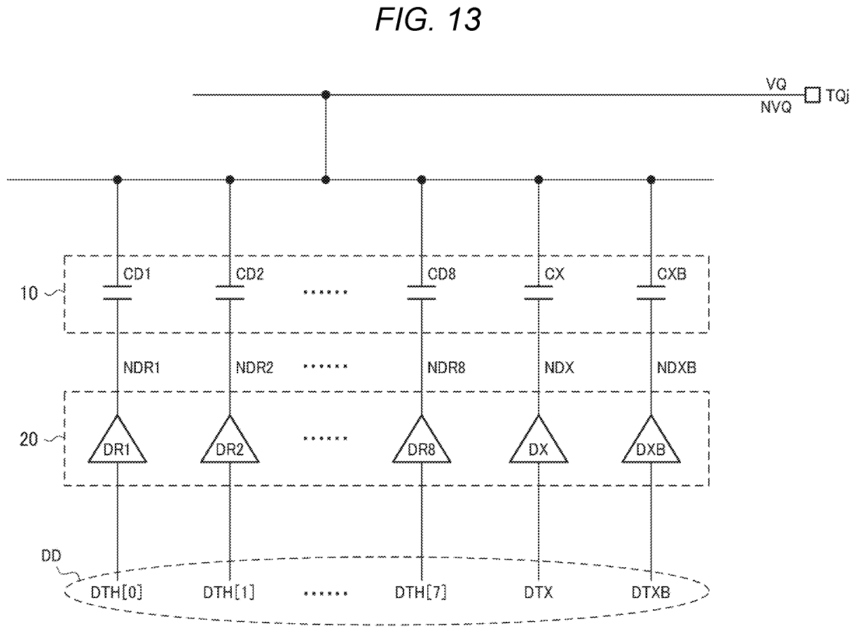

FIG. 13 shows an example of detailed configurations of the capacitor circuit 10 and the capacitor driving circuit 20 in the second embodiment. The capacitor circuit 10 includes the capacitors CD1 to CD8, which are the first to eighth capacitors, a capacitor CX, which is a ninth capacitor, and a capacitor CXB, which is a tenth capacitor. The capacitor driving circuit 20 includes the driving circuits DR1 to DR8, which are the first to eighth driving circuits, a driving circuit DX, which is a ninth driving circuit, and a driving circuit DXB, which is a tenth driving circuit. Note that the number of the capacitors and the driving circuits is equal to the number of bits of the capacitive driving data DD, and may be n.

One end of the capacitor CX is coupled to the output node NVQ, and the other end thereof is coupled to a capacitor driving node NDX. One end of the capacitor CXB is coupled to the output node NVQ, and the other end thereof is coupled to a capacitor driving node NDXB. The capacitance value of the capacitor CX and the capacitance value of the capacitor CXB are equal to each other. Specifically, the capacitance values of the capacitors CX and CXB are equal to the capacitance value of any one of the capacitors CD1 to CD8, and are determined in accordance with the number of gradations to be expanded in the overdriving. The capacitance values of the capacitors CX and CXB are, for example, equal to that of the capacitor CD5 when it is desired to expand the number of gradations by 32.

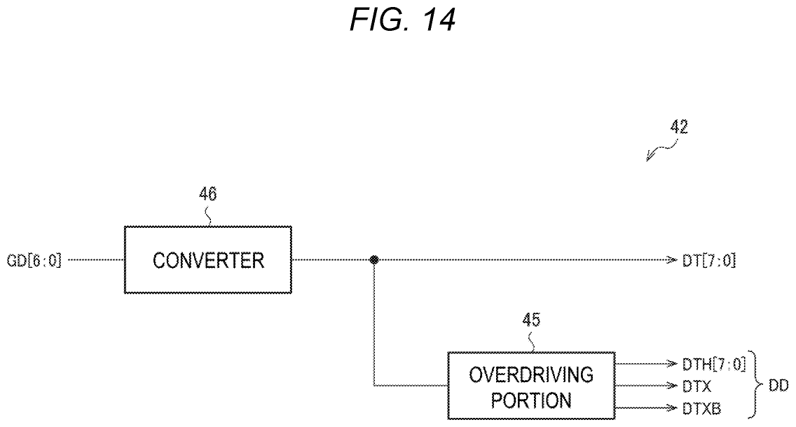

FIG. 14 shows an example of a detailed configuration of the processing circuit 42 in the second embodiment. The processing circuit 42 includes the overdriving portion 45 and the converter 46.

The overdriving portion 45 performs the overdriving on the gradation data DT[7:0], and outputs capacitive driving data DD containing the gradation data DTH[7:0] for capacitive driving and the signals DTX and DTXB for overdriving. In the periods other than the period TA, DTH[7:0]=DT[7:0], DTX=L, and DTXB=H. In the period TA, the overdriving portion 45 outputs the capacitive driving data DD in accordance with (a) and (b) below. It is assumed in the description that the number of gradations to be expanded is 32=10000b. The amount of overdrive Δov is calculated in the same manner as in the first embodiment.

(a) Δov≥0

The overdriving portion 45 prepares data AX[4:0] for calculation, in which AX[4]=0 and AX[3:0]=DT[3:0], and adds Δov to AX[4:0].

After the addition of Δov, the overdriving portion 45
outputs DTH[7:0]=DT[7:0]+Δov and DTX=L when AX[4]=0, and
outputs DTH[7:0]=DT[7:0]+Δov−32 and DTX=H when AX[4]=1.

It can also be said that DTH[7:0]=DT[7:0]+Δov−32 and DTX=H are output when the result of the addition of Δov to DT[3:0] is greater than or equal to 32. Note that DTXB=H.

(b) Δov<0

The overdriving portion 45 prepares data AXB[4:0] for calculation, in which AXB[4]=1 and AXB[3:0]=DT[3:0], and adds Δov to AXB[4:0].

After the addition of Δov, the overdriving portion 45
outputs DTH[7:0]=DT[7:0]+Δov and DTXB=H when AXB[4]=1, and
outputs DTH[7:0]=DT[7:0]+Δov+32 and DTXB=L when AXB[4]=0.

It can also be said that DTH[7:0]=DT[7:0]+Δov+32 and DTXB=L are output when the result of the addition of Δov to DT[3:0]+32 is smaller than 32. Note that DTX=L.

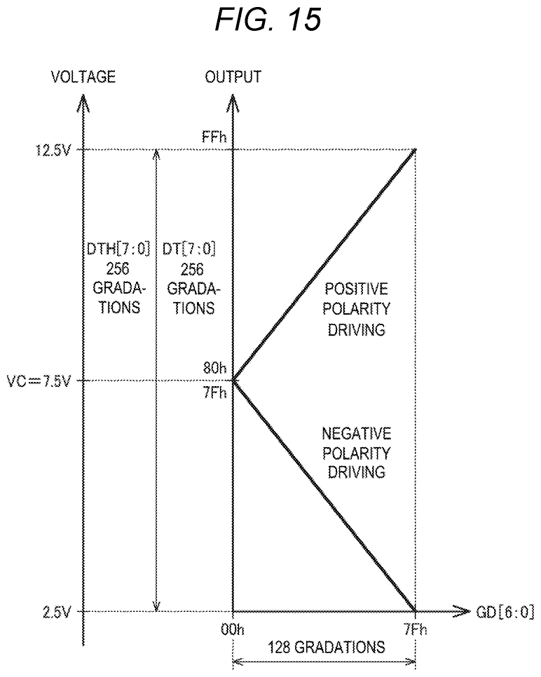

FIG. 15 shows the correspondence between the gradation data and the data voltage in the second embodiment. In the second embodiment, all the 128 gradations from 00h to FFh of the gradation data GD[6:0] are used as gradations used to display an image.

In the positive polarity driving, the converter 46 converts the gradation data GD[6:0]=00h, 01h, 02h, . . . , FFh into the gradation data DT[7:0]=80h, 81h, 82h, . . . , FFh. In the negative polarity driving, the converter 46 converts the gradation data GD[6:0]=00h, 01h, 02h, . . . , FFh into the gradation data DT[7:0]=7Fh, 7Eh, 7Dh, . . . , 00h. In the capacitive driving, a voltage in the range between 2.5 V and 12.5 V is output for 256 gradations from 00h to FFh of the gradation data DT[7:0]. Specifically, a voltage in the range between 7.5 V and 12.5 V is output for 80h to FFh in the positive polarity driving, and a voltage in the range between 7.5 V and 2.5 V is output for 7Fh to 00h in the negative polarity driving.

The overdriving portion 45 receives the gradation data DT[7:0] indicating 256 gradations, and outputs the gradation data DTH[7:0] indicating 256 gradations and the signals DTX and DTXB for overdriving. The gradation range is substantially expanded by the signals DTX and DTXB for overdriving, so that it is not necessary to provide a gradation region for overdriving, and all the 256 gradations are used to display an image. For example, in (a) described above, it is assumed that DT[7:0]=FFh=255=11111111b and Δov=32=10000b. When Δov=10000b is added to AX[4:0]=01111b, AX[4]=1 is satisfied. In this process, DT[7:0]+Δov=255+32, which exceeds the full scale of the gradation, but according to (a) described above, DTH[7:0]=255+32−32=255=FFh and DTX=H are output. That is, the gradation range during the overdriving is substantially expanded upward by 32 gradations. Similarly, according to (b) described above, the gradation range during the overdriving is substantially expanded downward by 32 gradations.

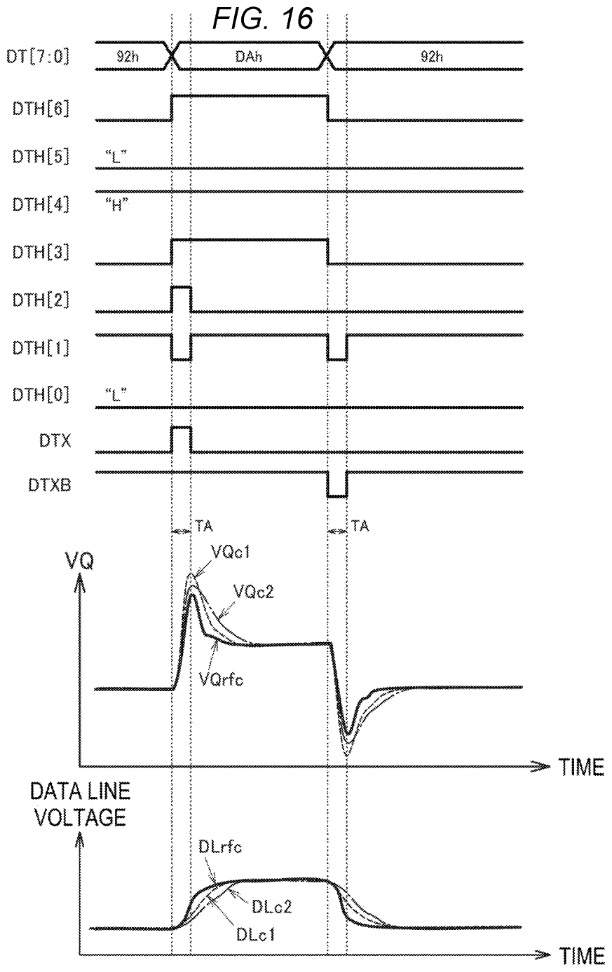

FIG. 16 shows an example of the signal waveforms in the second embodiment produced when the overdrive function is on. FIG. 16 shows a case where the overdrive coefficient Cov is 0.25. GD[6:0] and DTH[7] are not shown in FIG. 16, but are the same as those in FIG. 10 in the first embodiment.

When the gradation data DT[7:0] changes from 92h to DAh=11011010b, AX[4:0]=01010b and Δov=0.25×(DAh−92h)=10010b are satisfied. Since AX[4:0]+Δov=11100b, AX[4] after the addition is 1. According to (a) described above, in the period TA, DTH[7:0]=DT[7:0]+Δov−32=11011010b+10010b−10000b=11011100b, and DTX=H are satisfied.

When the gradation data DT[7:0] changes from DAh to 92h=10010010b, AXB[4:0]=10010b and |Δov|=0.25×(DAh−92h)=10010b are satisfied. Since AX [4:0]−|Δov|=00000b, AXB[4] after the addition is 0. According to (b) described above, in the period TA, DTH[7:0]=DT[7:0]−|Δov|+32=10010010b−10010b+10000b=10010000b, and DTXB=L are satisfied.

Waveforms VQrfc and DLrfc are examples of the waveforms produced when the capacitance CLCD and the input resistor RV of the electro-optical panel 200 have reference values. Waveforms VQc1 and DLc1 are examples of the waveforms produced when the capacitance CLCD is greater than the reference value. Waveforms VQc2 and DLc2 are examples of the waveforms produced when the input resistor RV has resistance greater than the reference value. As in the first embodiment, the voltage VQ at the output node NVQ and the data line voltage asymptotically approach the target voltages faster than when the overdrive function is off. Furthermore, expanding the gradation range during the overdriving prevents restriction of the gradation range within which an image is displayed.

Note that the method for calculating the capacitive driving data DD is not limited to (a) or (b) described above. The overdriving portion 45 may calculate the capacitive driving data DD in accordance, for example, with (c) or (d) described below.

(c) Δov≥0

The overdriving portion 45
outputs DTH[7:0]=DT[7:0]+Δov and DTX=L when DT[7:0]+Δov≤255, and
outputs DTH[7:0]=DT[7:0]+Δov−32 and DTX=H when DT[7:0]+Δov>255.
   (d) Δov<0

The overdriving portion 45
outputs DTH[7:0]=DT[7:0]+Δov and DTXB=H when DT[7:0]+Δov≥0, and
outputs DTH[7:0]=DT[7:0]+Δov+32 and DTXB=L when DT[7:0]+Δov<0.

### 4. Third Embodiment

In the third embodiment, when an overflow of the gradation data DTH[7:0] occurs, the overdriving portion 45 extends the length of the overflow period while restricting the gradation data DTH[7:0] to a limit value. The approach described above is applicable to both the first and second embodiments.

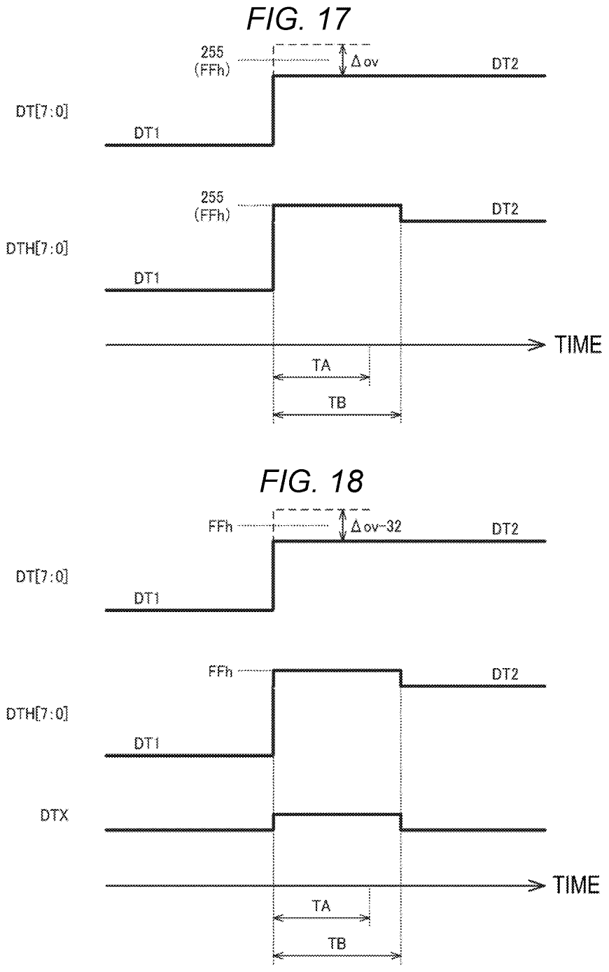

FIG. 17 illustrates a case where the approach in the third embodiment is applied to the first embodiment. FIG. 17 shows an example of the waveforms for an upper limit value FFh=255. The overdriving portion 45 determines the overdrive period and the capacitive driving data DD in accordance with (e) described below. Note that a lower limit value is 00h=0. The length of a period TB may be fixed, or may be longer as the degree of the overflow is greater.

### (e) the Overdriving Portion 45

outputs DTH[7:0]=DT[7:0]+Δov in the period TA when 0≤DT[7:0]+Δov>255,
outputs DTH[7:0]=255 in the period TB longer than the period TA when DT[7:0]+Δov>255, and
outputs DTH[7:0]=0 in the period TB when DT[7:0]+Δov<0.

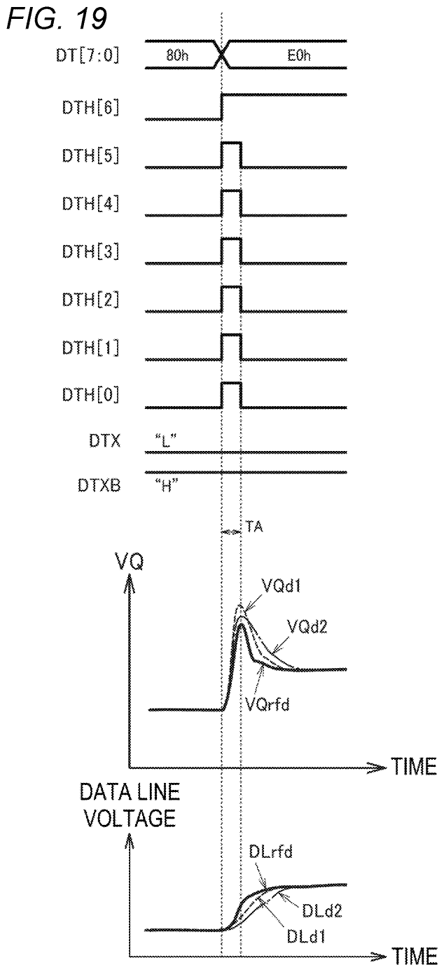

FIG. 18 illustrates a case where the approach in the third embodiment is applied to the second embodiment. FIG. 19 shows an example of the waveforms for the upper limit value FFh=255. The overdriving portion 45 determines the overdrive period and the capacitive driving data DD in accordance with (f) or (g) described below. Note that the description will be made with reference to (c) and (d) in the second embodiment, and that also in (a) and (b), when a non-restricted DTH[7:0] overflows, the overdrive period may be extended while restricting the DTH[7:0].

(f) Δov≥0

The overdriving portion 45
outputs DTH[7:0]=DT[7:0]+Δov and DTX=L in the period TA when DT[7:0]+Δov≤255,
when DT[7:0]+Δov>255,
outputs DTH[7:0]=DT[7:0]+Δov−32 and DTX=H in the period TA when DTH[7:0]=DT[7:0]+Δov−32≤255 by expanding the gradation range due to DTX=H and
outputs DTH[7:0]=255 and DTX=H in the period TB longer than the period TA when DTH[7:0]=DT[7:0]+Δov−32>255 even by expanding the gradation range due to DTX=H.
   (g) Δov<0

The overdriving portion 45
outputs DTH[7:0]=DT[7:0]+Δov and DTXB=H in the period TA when DT[7:0]+Δov≥0,
when DT[7:0]+Δov<0,
outputs DTH[7:0]=DT[7:0]+Δov+32 and DTXB=L in the period TA when DTH[7:0]=DT[7:0]+Δov+32≥0 by expanding the gradation range due to DTXB=L and
outputs DTH[7:0]=0 and DTXB=L in the period TB when DTH[7:0]=DT[7:0]+Δov+32<0 even by expanding the gradation range due to DTXB=L.

FIG. 19 shows an example of the signal waveforms produced when no overflow occurs. FIG. 19 shows a case where the approach in the third embodiment is applied to (c) and (d) in the second embodiment. Note that FIG. 19 does not show GD[6:0] or DTH[7]. GD[6:0]=00h, 60h, and DTH[7]=1 are satisfied. In this example, DT[7:0]+Δov is 255=111111b and does not exceed a limit value 255. Therefore, in the period TA, DTH[7:0]=DT[7:0]+Δov=111111b and DTX=L are output. Since sufficient overdrive is obtained, the output voltage VQ can be caused to rapidly but asymptotically approach the target voltage.

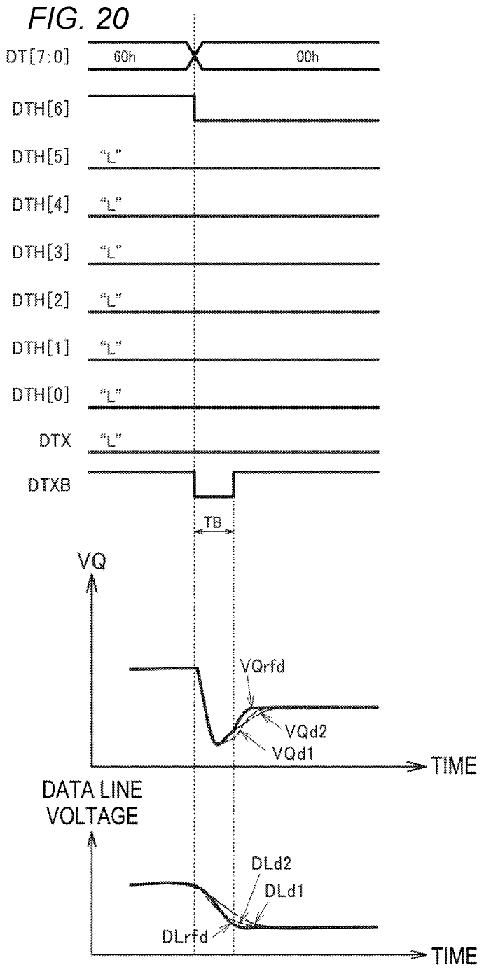

FIG. 20 shows an example of the signal waveforms produced when an overflow occurs. FIG. 20 shows the case where the approach in the third embodiment is applied to (c) and (d) in the second embodiment. Note that FIG. 20 does not show GD[6:0] or DTH[7]. GD[6:0]=60h, 00h, and DTH[7]=0 are satisfied. In this example, since DT[7:0] after the gradation changes is 00h, DT[7:0]+Δov falls below a limit value 0. Therefore, in the period TB, DTH[7:0]=00000000b and DTXB=L are output. Since the amount of overdrive is insufficient, the speed at which the output voltage VQ asymptotically approaches the target voltage slightly decreases, but extending the overdrive period TB allows the output voltage VQ to asymptotically approach the target voltage in a sufficiently short period.

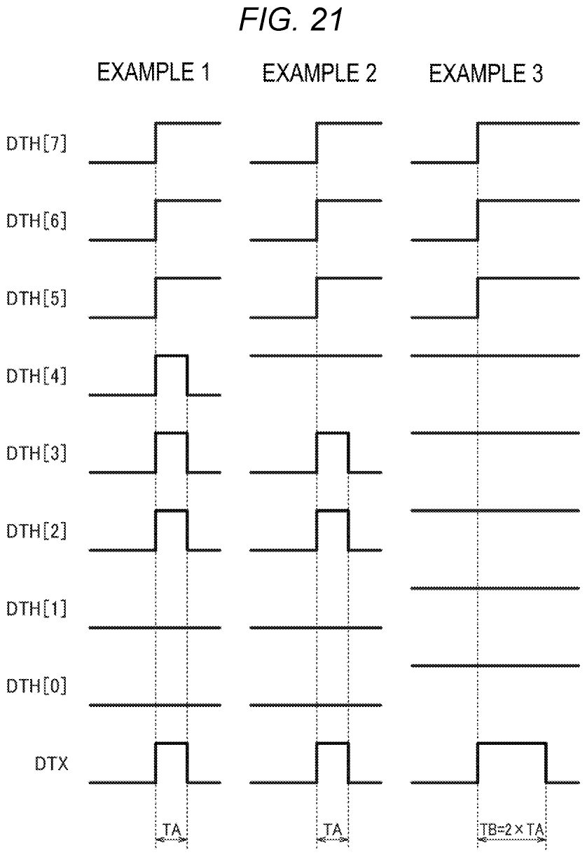

FIG. 21 illustrates extension of a period when an overflow occurs. The overflow coefficient Cov is set to ⅛. This means that the amount of overdrive results from downshifting the bit where the gradation has changed by 3 bits.

In Example 1, DTH[7], DTH[6], and DTH[5] change from 0 to 1 except for the overdriving in the period TA. Therefore, during the overdriving in the period TA, DTH[4], DTH[3], and DTH[2] become 1. The amount of overdrive is 1Ch. Since DTH[7:0] does not exceed the limit value FFh, DTX=L is satisfied, and the period TA is not extended.

Example 2 is similar to Example 1 except for DTH[4]=1. Further adding 1 to DTH[4] during the overdriving causes DTH[7:0] to exceed the limit value FFh, so that DTX=H in the period TA. DTH[7:0] can be smaller than or equal to the limit value FFh because DTX=H, so that the period TA is not extended. Furthermore, the amount of overdrive of 1Ch is fulfilled by 10h resulting from DTX=H and 0Ch resulting from DTH[4]=DTH[3]=1. It can therefore be considered that the period TA is not extended.

Example 3 is similar to Example 1 except that DTH[4] to DTH[0] are set to 1. Even when DTX=H, DTH[7:0] exceeds the limit value FFh, so that the period TA is extended to the period TB. Furthermore, the amount of overdrive of 1Ch is not fulfilled by 10h resulting from DTX=H, and falls short by 0Ch. It can therefore be considered that the period TA is extended to the period TB. When it is considered that the amount of overdrive is partly fulfilled by 10h resulting from DTX=H in the period TA, it can be considered that the amount of overdrive can be fulfilled by another 10h resulting from DTX=H provided by extension corresponding to the period TA. Accordingly, 1Ch<2×10h is satisfied, so that the amount of overdrive 1Ch is fulfilled. That is, TB=2×TA is satisfied. When even 2×TA cannot fulfill the amount of overdrive, the period TB may be extended to 3×TA, 4×TA, . . . .

Whether to further add the period TA to the period TB in response to the shortage of the amount of overdrive may be determined by comparison of the amount of shortage with a threshold. When the amount of shortage is greater than or equal to the threshold, the period TA is further added to the period TB, and when the amount of shortage is smaller than the threshold, the period TA is not added to the period TB.

In the present embodiment described above, the driver 100 includes the first to n-th capacitors, the capacitor driving circuit 20, and the control circuit 40. n is an integer greater than or equal to two. The first to n-th capacitors are provided between the output terminal TQj, which is electrically coupled to the signal supply line SLj of the electro-optical panel 200, and first to n-th capacitor driving nodes. The capacitor driving circuit 20 outputs first to n-th capacitor driving voltages corresponding to the capacitive driving data DD to the first to n-th capacitor driving nodes. The control circuit 40 outputs the capacitive driving data DD based on the gradation data DT[7:0]. The control circuit 40 sets the capacitive driving data DD in a way that the amount of electric charge at the node NVQ of the output terminal TQj is changed by the amount of change in electric charge greater than the amount of change in electric charge corresponding to the amount of change ΔG1 in the gradation data DT[7:0] in a predetermined period where the gradation data DT[7:0] changes.

In the first embodiment shown in FIGS. 2 to 11, the capacitors CD1 to CD8 correspond to the first to n-th capacitors, the gradation data DTH[7:0] for capacitive driving corresponds to the capacitive driving data DD, and the period TA corresponds to the predetermined period. In the second embodiment shown in FIGS. 12 to 16, the capacitors CD1 to CD8, CX, and CXB correspond to the first to n-th capacitors, the gradation data DTH[7:0] for capacitive driving and the signals DTX and DTXB for overdriving correspond to the capacitive driving data DD, and the period TA corresponds to the predetermined period. In the third embodiment shown in FIGS. 17 to 21, the period TA or the period TB corresponds to the predetermined period.

According to the present embodiment, in the predetermined period where in the gradation data DT[7:0] changes, the amount of electric charge at the node NVQ of the output terminal TQj changes by the amount of change in electric charge greater than the amount of change in electric charge corresponding to the amount of change ΔG1 in the gradation data DT[7:0]. The voltage VQ at the output node NVQ therefore greatly rises as compared with the case where the amount of electric charge at the node NVQ of the output terminal TQj is changed by the amount of change in electric charge corresponding to the amount of change ΔG1 in the gradation data DT[7:0] in the predetermined period. The speed at which the electric charge is moved between the output node NVQ and the data lines thus increases, so that the voltage VQ at the output node NVQ and the data line voltage quickly but asymptotically approach the target voltage. That is, the writing period to the pixels is shortened.

As described with reference to FIG. 4 in the first embodiment, at the timing when the gradation data DT[7:0] changes by the first amount of change ΔG1, the control circuit 40 may change the gradation data DT[7:0] by the second amount of change ΔG2 greater than the first amount of change ΔG1 and output the changed gradation data DT[7:0] as the capacitive driving data DD (DTH[7:0]) in the predetermined period (TA).

According to the present embodiment, the electric charge corresponding to the second amount of change ΔG2 is supplied by the capacitive driving to the output node NVQ in the predetermined period. The amount of electric charge at the node NVQ of the output terminal TQj can thus be changed by the amount of change in electric charge greater than the amount of change in electric charge corresponding to the amount of change ΔG1 in the gradation data DT[7:0].

In the first embodiment, the control circuit 40 may add the amount of overdrive Δov, which is the first amount of change ΔG1 multiplied by the overdrive coefficient Cov, to the gradation data DT[7:0]=DT2 having changed by the first amount of change ΔG1 in the predetermined period (TA), and output the resultant gradation data as the capacitive driving data DD (DTH [7:0]).

According to the present embodiment, the second amount of change ΔG2 is the sum of the first amount of change ΔG1 and the amount of overdrive Δov. The second amount of change ΔG2 greater than the first amount of change ΔG1 is thus achieved. The overdriving can be performed by using an appropriate amount of overdrive Δov according to the first amount of change ΔG1.

As described with reference to FIGS. 12 to 14 in the second embodiment, the control circuit 40 may output the first to (n−2)-th bits of the n-bit capacitive driving data DD as the gradation data DTH[n−3:0] for capacitive driving based on the gradation data DT[7:0]. The control circuit 40 may output the (n−1)-th bit as the first signal DTX for overdriving and output the n-th bit as the second signal DTXB for overdriving. The capacitor driving circuit 20 may drive the first to (n−2)-th capacitors CD1 to CDn-2 out of the first to n-th capacitors based on the gradation data DTH[n−3:0] for capacitance driving. The capacitor driving circuit 20 may drive the (n−1)-th capacitor CX having a capacitance value equal to that of a q-th capacitor CDq out of the first to n-th capacitors based on the first signal DTX. q is an integer greater than or equal to 1 but smaller than or equal to n−2. The capacitor driving circuit 20 may drive the n-th capacitor CXB having a capacitance value equal to that of the q-th capacitor CDq out of the first to n-th capacitors based on the second signal DTXB. In the second embodiment, n=10 and q=5.

As described with reference to FIG. 15, since the gradation range is substantially expanded by the first signal DTX and the second signal DTXB for overdriving, it is not necessary to provide a gradation region for overdriving. The overdriving can thus use the gradation range of the gradation data DTH[n−3:0] for capacitive driving to display an image without any restriction.

In the second embodiment, when the gradation data DT[7:0] increases at the timing when the gradation data DT[7:0] changes, the control circuit 40 may change the first signal DTX from the low level to the high level in the predetermined period (TA). In addition, the control circuit 40 may add the amount of overdrive Δov to the gradation data DT[7:0], subtract the gradation value (32) corresponding to the q-th bit DTH[q−1] of the gradation data DTH[n−3:0] for capacitive driving from the gradation data DT[7:0], and output the resultant gradation data as the gradation data DTH[n−3:0] for capacitive driving. When the gradation data DT[7:0] decreases at the timing when the gradation data DT[7:0] changes, the control circuit 40 may change the second signal DTXB from the high level to the low level in the predetermined period (TA). In addition, the control circuit 40 may add the amount of overdrive Δov to the gradation data DT[7:0], add the gradation value (32) corresponding to the q-th bit DTH[q−1] of the gradation data DTH[n−3:0] for capacitive driving to the gradation data DT[7:0], and output the resultant gradation data as the gradation data DTH[n−3:0] for capacitive driving.

According to the present embodiment, while the first signal DTX is set to the high level, the gradation value corresponding thereto is subtracted from the gradation data DTH[n−3:0] for capacitive driving. Instead, while the second signal DTXB is set to the low level, the gradation value corresponding thereto is added to the gradation data DTH[n−3:0] for capacitive driving. The gradation range in the overdriving is thus substantially expanded.

In the second embodiment, at the timing when the gradation data DT[7:0] changes by the first amount of change ΔG1, the amount of overdrive Δov may be the first amount of change ΔG1 multiplied by the overdrive coefficient Cov.

According to the present embodiment, the amount of overdrive Δov can be calculated by multiplying the first amount of change ΔG1 by the overdrive coefficient Cov.

As described with reference to FIG. 17 in the third embodiment, when the capacitive driving data DD (DTH[7:0] in first embodiment) in the predetermined period exceeds the limit value (0 or 255), the control circuit 40 may restrict the capacitive driving data DD to a limit value and extend the predetermined period. In the example shown in FIG. 17, the extended predetermined period is the period TB.

As described with reference to FIG. 18 in the third embodiment, when the gradation data for capacitive driving (DTH[7:0] in second embodiment) in the predetermined period exceeds a limit value (0 or 255), the control circuit 40 may restrict the gradation data for capacitive driving to the limit value and extend the predetermined period. In the example shown in FIG. 18, the extended predetermined period is the period TB.

According to the third embodiment described above, when the gradation data for capacitive driving DTH[7:0] exceeds the upper limit or the lower limit due to the overdriving, the gradation data for capacitive driving DTH[7:0] can be restricted to the upper limit or the lower limit. Although the amount of overdrive is insufficient due to the restriction of the gradation data, the insufficiency can be compensated by extending the predetermined period for which the overdriving is performed.

### 5. Electronic Instrument

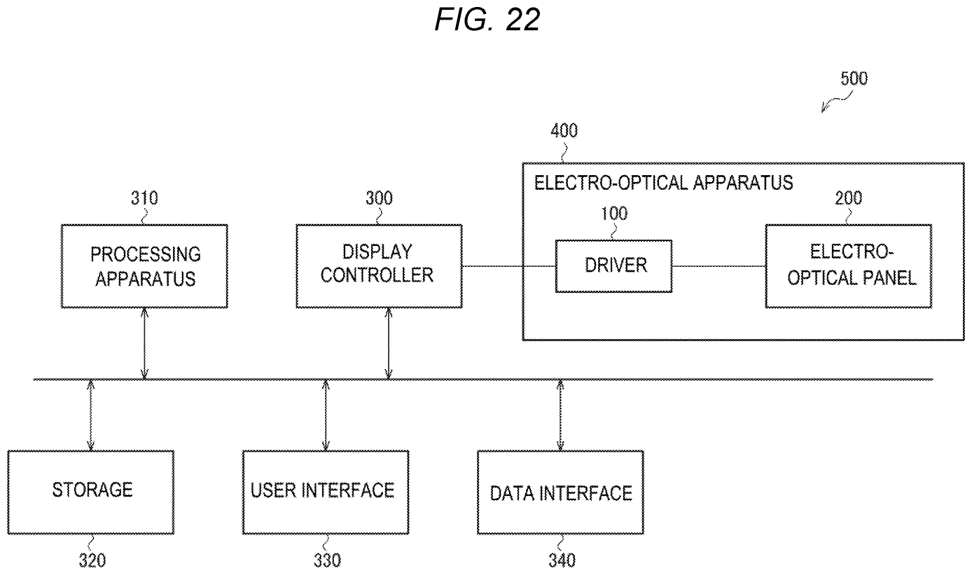

FIG. 22 shows an example of the configuration of an electronic instrument 500 including the driver 100. As the electronic instrument 500, various electronic instruments equipped with a display apparatus are conceivable. For example, the electronic instrument 500 is a projector, a television apparatus, an information processing apparatus, a portable information terminal, a car navigation system, or a portable game terminal.

The electronic instrument 500 includes the electro-optical apparatus 400, the display controller 300, a processing apparatus 310, a storage 320, a user interface 330, and a data interface 340. The electro-optical apparatus 400 includes the driver 100 and the electro-optical panel 200.

The user interface 330 is an interface that accepts various operations from a user. The user interface 330 includes, for example, buttons, a mouse, a keyboard, or a touch panel incorporated into the electro-optical panel 200. The data interface 340 is an interface via which image data or control data is input and output. The data interface 340 is, for example, a wired communication interface such as USB, or a wireless communication interface such as a wireless LAN. The storage 320 stores the image data input via the data interface 340. The storage 320 instead functions as a working memory of the processing apparatus 310 or the display controller 300. The processing apparatus 310 controls each portion of the electronic instrument and performs various types of data processing. The processing apparatus 310 is, for example, a processor such as a CPU or a microcomputer. The display controller 300 controls the driver 100. For example, the display controller 300 converts the image data transferred from the data interface 340 or the storage 320 into a format that can be accepted by the driver 100, and outputs the converted image data to the driver 100. The driver 100 drives the electro-optical panel 200 based on the image data transferred from the display controller 300.

Note that the present embodiment has been described above in detail, and a person skilled in the art may readily understand that many variations are conceivable without substantively departing from the novel items and advantages of the present disclosure. It is therefore intended that all such variations fall within the scope of the present disclosure. For example, a term described at least once together with a different term having a broader meaning or the same meaning in the specification or the drawings can be replaced with the different term in any part of the specification or the drawings. All combinations of the present embodiment and the variations also fall within the scope of the present disclosure. The configurations, operations, and other factors of the control circuit, the output circuits, the driver, the electro-optical panel, the electro-optical apparatus, the display driver, the electronic instrument, and the like are not limited to those described in the present embodiment, and various changes can be made.

What is claimed is:

1. A driver comprising:
first to n-th capacitors provided between an output terminal electrically coupled to a signal supply line of an electro-optical panel and first to n-th capacitor driving nodes, wherein n is an integer greater than or equal to two;
a capacitor driving circuit configured to output first to n-th capacitor driving voltages corresponding to capacitive driving data to the first to n-th capacitor driving nodes; and
a control circuit configured to output the capacitive driving data based on gradation data,
wherein the control circuit is configured to set the capacitive driving data in a way that an amount of electric charge at a node of the output terminal is changed by an amount of change in electric charge greater than an amount of change in electric charge corresponding to an amount of change in the gradation data in a predetermined period containing a change timing when the gradation data changes.

2. The driver according to claim 1, wherein
when the gradation data changes by a first amount of change at the change timing, the control circuit is configured to change the gradation data by a second amount of change greater than the first amount of change and output the changed gradation data as the capacitive driving data in the predetermined period.

3. The driver according to claim 2, wherein
the control circuit is configured to add an amount of overdrive that is the first amount of change multiplied by an overdrive coefficient to the gradation data after the change by the first amount of change and output the resultant gradation data as the capacitive driving data in the predetermined period.

4. The driver according to claim 1, wherein
the control circuit is configured to output first to (n−2)-th bits of the capacitive driving data, which is n-bit data, as gradation data for capacitance driving, output an (n−1)-th bit as a first signal for overdriving, and output an n-th bit as a second signal for overdriving based on the gradation data, and
the capacitor driving circuit is configured to
drive first to (n−2)-th capacitors out of the first to n-th capacitors based on the gradation data for capacitance driving,
drive an (n−1)-th capacitor having a capacitance value equal to a capacitance value of a q-th capacitor out of the first to n-th capacitors based on the first signal, wherein q is an integer greater than or equal to 1 but smaller than or equal to n−2, and
drive an n-th capacitor having a capacitance value equal to the capacitance value of the q-th capacitor out of the first to n-th capacitors based on the second signal.

5. The driver according to claim 4, wherein
when the gradation data increases at the change timing, the control circuit is configured to change the first signal from a low level to a high level in the predetermined period, add an amount of overdrive to the gradation data, subtract a gradation value corresponding to a q-th bit of the gradation data for capacitance driving from the gradation data, and output a resultant gradation data as the gradation data for capacitance driving, and
when the gradation data decreases at the change timing, the control circuit is configured to change the second signal from the high level to the low level in the predetermined period, add the amount of overdrive to the gradation data, add a gradation value corresponding to the q-th bit of the gradation data for capacitance driving to the gradation data, and output a resultant gradation data as the gradation data for capacitance driving.

6. The driver according to claim 5, wherein
when the gradation data changes by a first amount of change at the change timing, the amount of overdrive is the first amount of change multiplied by an overdrive coefficient.

7. The driver according to claim 2, wherein
when the capacitive driving data in the predetermined period exceeds a limit value, the control circuit is configured to restrict the capacitive driving data to the limit value and extend the predetermined period.

8. The driver according to claim 4, wherein
when the gradation data for capacitive driving in the predetermined period exceeds a limit value, the control circuit is configured to restrict the gradation data for capacitive driving to the limit value and extend the predetermined period.

9. An electro-optical apparatus comprising:
the driver according to claim 1; and
the electro-optical panel.
